(19) United States
(12) Patent Application Publication
(10) Pub. No.: US 2014/0157736 A1
(43) Pub. Date: Jun. 12, 2014

(54) AIR CLEANER MOUNTED IN ENGINE OF VEHICLE

(71) Applicants: Kia Motors Corporation, Seoul (KR); Hyundai Motor Company, Seoul (KR)

(72) Inventor: Won Seop Choi, Anyang (KR)

(73) Assignees: KIA MOTORS CORPORATION, Seoul (KR); HYUNDAI MOTOR COMPANY, Seoul (KR)

(21) Appl. No.: 14/103,342

(22) Filed: Dec. 11, 2013

(30) Foreign Application Priority Data
Dec. 12, 2012 (KR) 10-2012-0144879

(51) Int. Cl. F02M 35/02

(52) U.S. Cl. CPC F02M 35/0201
USPC 55/385.3; 55/480

(57) ABSTRACT

An air cleaner is mounted on an upper portion of an engine. The air cleaner includes: a body disposed on an upper part of the engine and having a space in which a filter is received; a cover covering an upper part of the body and having a hinge member protruded from a rear edge of the cover; and a locking member including a support portion integrally formed at a rear edge of the body, and a coupling portion protruded upwardly from the support portion and provided with an opening hinged by the hinge member of the cover inserted between the coupling portion and the support member, where an upper surface and a lower surface of an insertion portion inserted into the opening of the locking member from the hinge member are inclined downward toward the rear edge of the body.

### CROSS-REFERENCE TO RELATED APPLICATION

This application is based on and claims under 35 U.S.C. §119(a) priority from Korean Patent Application No. 10-2012-0144879, filed on Dec. 12, 2012 in the Korean intellectual Property Office, the disclosure of which is incorporated herein in its entirety by reference.

### BACKGROUND

(a) Field of the Invention

The present invention relates to an air cleaner mounted in an engine room of a vehicle. More particularly, the present invention relates to an air cleaner having a cover, the air cleaner being easily mounted to an engine in the engine room of the vehicle to improve maintainability.

(b) Description of the Related Art

Generally, an air cleaner has a filter mounted therein to purify air introduced into an engine. An air cleaner according to the related art conventionally is mounted at a side of an engine in an engine room. Recently, however, as a size of a head lamp is increased, a layout of the engine room has narrowed, and therefore there is a need to change a position of the air cleaner.

Recently, as illustrated in FIG. 1 (RELATED ART), there has been provided a method for solving a layout problem by disposing an air cleaner 10 on an upper part of the engine. Further, as illustrated in FIG. 1, a cover 11 of the air cleaner 10 is fastened with bolts 20 so as to seal or maintain the air cleaner 10. In particular, a plurality of bolts 20 are detachably fastened along an edge of the air cleaner 10. Therefore, in order to make adjustments, a user would need to take action such as loosening the bolt 20, removing the cover 11, and the like, so as to exchange or maintain a filter, which are received in the air cleaner 10. As a result, there is a problem in that much effort and time are required tor the exchange or maintenance of the filter.

### SUMMARY

Accordingly, the present invention provides an air cleaner having a structure in which a cover is easily mounted or separated in or from the air cleaner, thereby facilitating exchange or maintenance of a filter.

In one aspect of the present invention, there is provided an air cleaner including: a body disposed on an upper part of an engine and provided with a space in which a filter is received; a cover covering an upper part of the body and provided with a hinge member protruded from a rear edge of the cover; and a locking member including a support portion integrally formed at a rear edge of the body and a coupling portion protruded upwardly from the support portion and provided with an opening hinged by the hinge member of the cover inserted between the coupling portion and the support portion, where an upper surface and a lower surface of an insertion portion inserted into the opening of the locking member from the hinge member ate inclined downward toward the rear edge of the body.

### BRIEF DESCRIPTION OF THE DRAWINGS

The above and other objects, features and advantages of the present invention will be more apparent from the following detailed description taken in conjunction with the accompanying drawings, in which:

FIG. 1 (RELATED ART) is a diagram illustrating an air cleaner according to the related art;

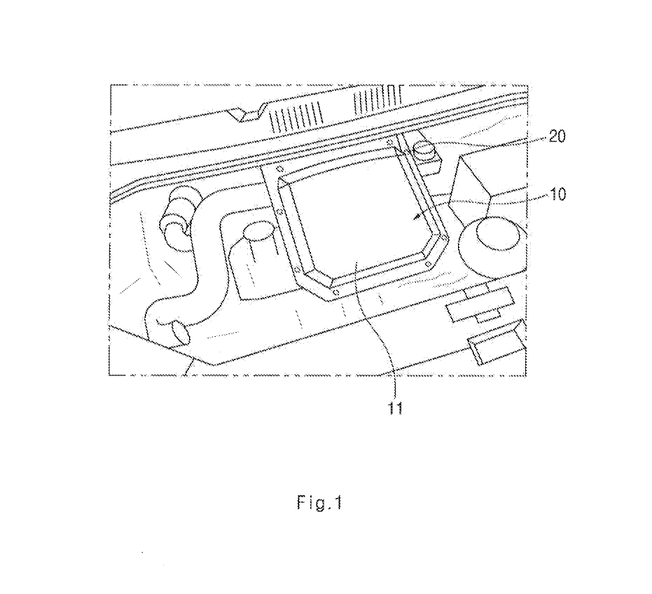

FIG. 2 is a diagram illustrating an air cleaner according to an embodiment of the present invention;

FIG. 3 is a cross-sectional view taken along the line A-A in FIG. 2 of a hinge portion of the air cleaner according to the embodiment of the present invention; and

FIG. 4 is a cross-sectional view illustrating an operation of mounting a cover of the air cleaner according to the embodiment of the present invention.

### DETAILED DESCRIPTION OF THE PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

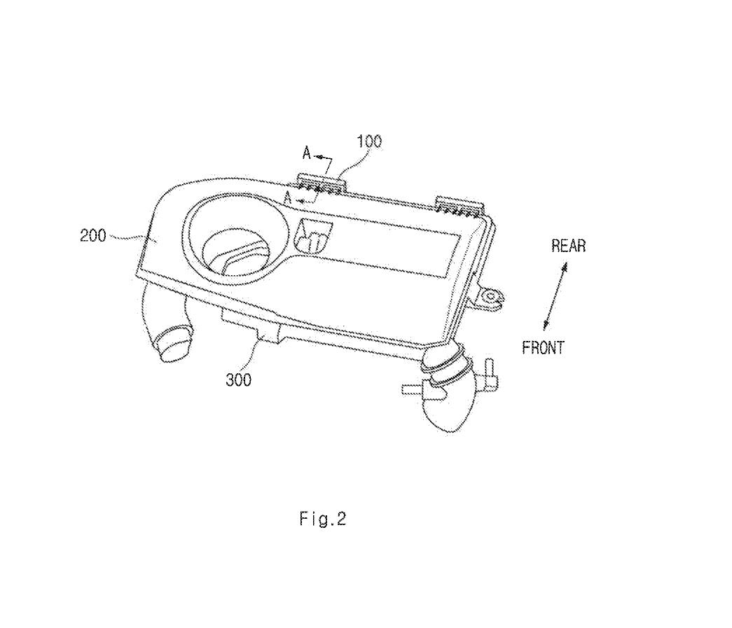

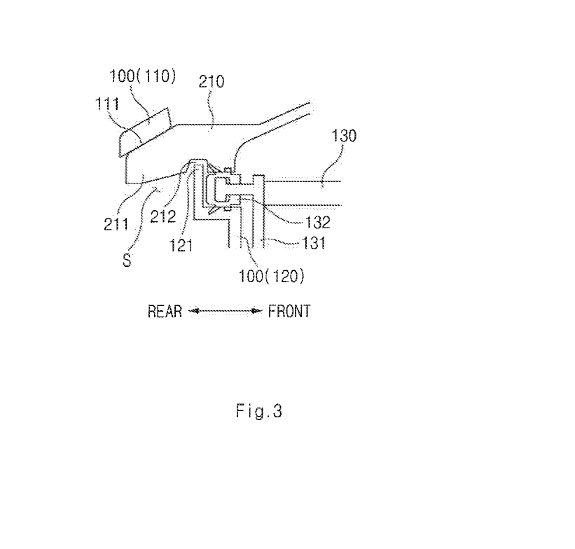

An embodiment of an air cleaner according to the present invention will be described in more detail with reference to the accompanying drawings. FIG. 2 is a diagram illustrating an air cleaner according to an embodiment of the present invention, and FIG. 3 is a cross-sectional view taken along the fine A-A of FIG. 2 of a hinge portion of the air cleaner according to the embodiment of the present invention. In describing the present invention, the terms, “front” and “rear” are based on “front” and “rear” in an arrow direction shown in FIGS. 2 and 3.

First, referring to FIGS. 2 and 3, the air cleaner according to the embodiment of the present invention is disposed on an upper part of an engine within an engine room. The air cleaner includes a body 300 having a filter 130 received therein and a cover 200 to open and close an upper part of the body 300. The cover 200 preferably is mounted on the body 300 by a hinge coupling method, not a bolt method according to the related art. Therefore, the cover 200 may be simply separated and mounted from and on the body 300.

In particular, a hinge member 210 is protruded from a mar edge of the cover 200. Further, a locking member 100 is integrally provided with the body 300 at a rear edge of the body 300. In the embodiment of the present invention, the hinge member 210 and the locking member 100 are provided as two separate parts, but the number of parts is not necessarily limited to two, and therefore may be variously changed according the design.

The locking member 100 includes a support portion 120 that is integrally formed on the body 300 and a coupling portion 110 that is protruded upwardly from the support portion 120. The hinge member 210 of the cover 200 is inserted between the coupling portion 110 and the support portion 120, and therefore a hinged opening S may be formed therebetween.

The hinge member 210 may be inclined downward toward the rear (i.e., in the rear direction of the body 300). In particular, an upper surface and a lower surface of the insertion portion 211 inserted into the opening S of the locking member 100 may be inclined downward toward the rear. Further, the insertion portion 211 may have a reduced thickness toward the rear. Additionally, a surface 111 contacting the upper surface of the insertion portion 211 of the hinge member 210 in the coupling portion 110 may also be inclined downward toward the rear.

Further, a lower surface of the hinge member 210 is provided with a depressed groove 212 that receives an upper end 121 of the support portion 120 of the locking member 100. In particular, the depressed groove 212 is inserted with the upper end 121 of the support portion 120 in the state in which the hinge member 210 is hinged with the locking member 100 to fix the hinge coupling. Therefore, it is possible to prevent the cover 200 from separating from the body 300 due to external vibrations.

By the shape, when the cover 200 is inserted into the locking member 100 fixed to the body 300 to be hinged therewith, the insertion portion 211 of the hinge member 210 may be easily inserted into the opening S formed in the locking member 100. Hereinafter, the operation thereof will be described in more detail.

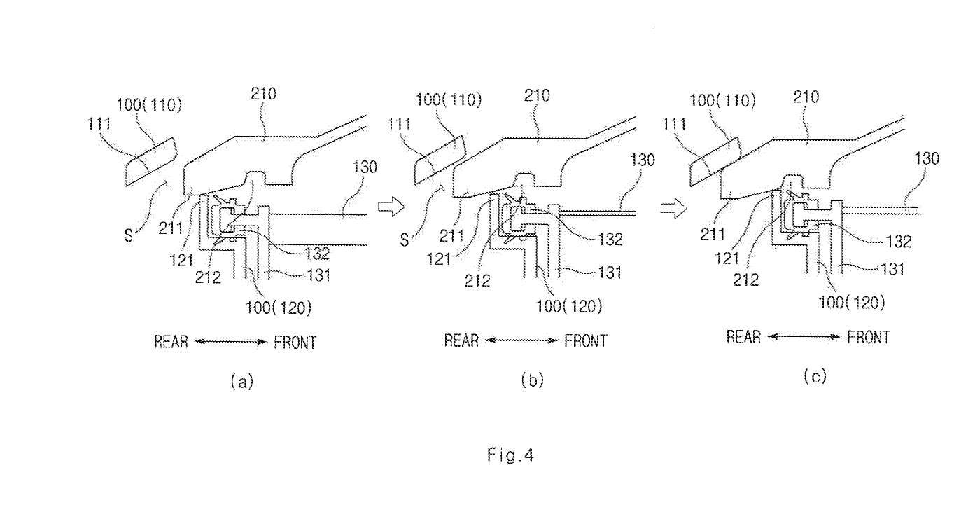

FIG. 4 is a diagram illustrating an action of the air cleaner according to the embodiment of the present invention. First, as illustrated in FIG. 4A, the filter 130 is disposed in the body 300 in the state in which the filter 130 is exchanged by separating the cover 200 of the air cleaner. In this case, a filter frame 131 supporting the edge of the filter 130 is disposed at a step portion formed along an edge of a side wall of the body 300. Further, the filter frame 131 is surrounded by an elastic member 132 of which the outer end has elasticity.

In this state, in order to mount the cover 200 on the upper part of the body 300, the hinge member 210 of the cover 200 is inserted into the opening S formed in the locking member 100. In this case, as illustrated in FIG. 4B, the insertion portion 211 of the hinge member 210 has the upper and lower surfaces inclined toward the rear, and therefore may be easily inserted into the opening S. Further, the insertion portion 211 of the hinge member 210 has a reduced thickness toward the rear.

Further, as the contacting surface 111 of the coupling portion 110 of the locking member 100 may be inclined downward toward the rear, as illustrated in FIG. 4C, when the insertion portion 211 of the hinge member 210 is inserted into the opening S, the insertion portion 211 does not contact the opening S, such that the insertion operation is not hindered. Therefore, the insertion portion 211 is more easily inserted into the opening S.

Therefore, when the insertion portion 211 of the hinge member 210 is completely inserted into the opening S, as illustrated in FIG. 3, the depressed groove 212 formed on the lower surface of the hinge member 210 is inserted with the upper end 121 of the support portion 120 of the locking member 100.

As described above, according to the embodiment of the present invention, when the insertion portion 211 of the hinge member 210 is inserted into the opening S, the insertion portion 211 does not generate a friction with the locking member 100 and also does not generate friction with the elastic member 132 that is present in the filter 130 before the insertion is completed. Therefore, according to the embodiment of the present invention, the cover 200 can be easily separated and coupled from and with the body 300 by using the hinge coupling method. As a result, the maintainability of the air cleaner is improved.

According to the embodiments of the present invention configured as described above, the inserting portion of the hinge member does not generate a friction with the locking member when being inserted into the opening of the locking member. Therefore, according to the embodiments of the present invention, the cover can be easily separated and coupled from and with the body by using the hinge coupling method, thereby improving the maintainability of the air cleaner.

The present invention is described with reference to the embodiments illustrated in the drawings, which are only example and can be implemented by various embodiments. Therefore, the true scope of the present invention will be defined only by claims.

What is claimed is:

1. An air cleaner, comprising:
a body disposed on an upper part of an engine and provided with a space in which a filter is received;
a cover covering an upper part of the body and provided with a hinge member protruded from a rear edge of the cover; and
a locking member including a support portion integrally formed at a rear edge of the body and a coupling portion protruded upwardly from the support portion and provided with an opening hinged by the hinge member of the cover inserted between the coupling portion and the support portion,
wherein an upper surface and a lower surface of an insertion portion inserted into the opening of the locking member from the hinge member are inclined downward toward the rear edge of the body.

2. The air cleaner according to claim 1, wherein a surface contacting the insertion portion of the hinge member in the coupling portion of the locking member is inclined downward toward the rear edge of the body.

3. The air cleaner according to claim 1, wherein the insertion portion of the hinge member has a reduced thickness toward the rear edge of the body.

4. The air cleaner according to claim 1, wherein the lower surface of the hinge member is provided with a depressed groove receiving an upper end of the support portion of the locking member when the hinge member is inserted into the opening of the locking member.

5. The air cleaner according to claim 2, wherein the lower surface of the hinge member is provided with a depressed groove receiving an upper end of the support portion of the locking member when the hinge member is inserted into the opening of the locking member.

6. The air cleaner according to claim 3, wherein the lower surface of the hinge member is provided with a depressed groove receiving an upper end of the support portion of the locking member when the hinge member is inserted into the opening of the locking member.

7. The air cleaner according to claim 1, wherein the air cleaner is configured to be installed in the engine of a vehicle.

8. An engine of a motor vehicle, comprising:
an air cleaner body installed in the engine, and provided with a space in which a filter is received;
a cover covering an upper part of the body and provided with a hinge member protruded from a rear edge of the cover; and
a locking member including a support portion integrally formed at a rear edge of the body and a coupling portion protruded upwardly from the support portion and provided with an opening hinged by the hinge member of the cover inserted between the coupling portion and the support portion,
wherein an upper surface and a lower surface of an insertion portion inserted into the opening of the locking member from the hinge member are inclined downward toward the rear edge of the body.

9. The engine of claim 8, wherein the air cleaner body is disposed on an upper part of the engine.

10. The engine of claim 8, wherein a surface contacting the insertion portion of the hinge member in the coupling portion of the locking member is inclined downward toward the rear edge of the body.

11. The engine of claim 8, wherein the insertion portion of the hinge member has a reduced thickness toward the rear edge of the body.

12. The engine of claim 8, wherein the lower surface of the hinge member is provided with a depressed groove receiving an upper end of the support portion of the locking member when the hinge member is inserted into the opening of the locking member.
